(19) United States
(12) Patent Application Publication
(10) Pub. No.: US 2025/0031032 A1
(43) Pub. Date: Jan. 23, 2025

(54) SYSTEM, DEVICE AND METHOD FOR PRIVACY PROTECTION OF ELECTRONIC DEVICES

(71) Applicant: CIROTTA TECH LTD, Tel-Aviv (IL)

(72) Inventors: Eran Yechiel EREZ, Tel-Aviv (IL); Shlomo EREZ, Tel-Aviv (IL)

(21) Appl. No.: 18/714,719

(22) PCT Filed: Dec. 1, 2022
(86) PCT No.: PCT/IL2022/051281

§ 371 Date: May 30, 2024

(30) Foreign Application Priority Data
Dec. 1, 2021 (IL) 288602

(51) Int. Cl. H04W 12/02; H01Q 1/24; H01Q 1/38; H01Q 9/30; H04B 1/3888; H04B 5/43; H04W 12/082; H04W 88/06

(52) U.S. Cl. CPC H04W 12/02; H01Q 1/242; H01Q 1/38; H04B 1/3888; H04B 5/43; H04W 12/082; H01Q 9/30; H04W 88/06

(57) ABSTRACT

A data protection system, method and case for use with an associated electronic device are presented. The system comprising one or more signal blocking antenna units and a control circuit. The one or more signal blocking antenna units are positioned to face respective one or more antenna units of said associated electronic device. The control circuit is configured and operable to operate said one or more signal blocking antenna units to transmit selected signal pattern for blocking communication to or from the respective antenna unit of the associated electronic device.

### TECHNOLOGICAL FIELD

The present disclosure relates to devices, systems, and techniques for enhancing privacy while using electronic devices, and specifically relates to device protection by selectively limiting communication capabilities of the device.

### BACKGROUND

Electronic devices, such as smartphone, laptops, and other mobile electronic and computerized devices, having become a necessity in recent years. For typical users, the personal computer and/or phone hold various types of private information and access keys to various other locations and services, being physical and/or virtual.

Various data encryption techniques are used to prevent third parties from eavesdropping on communication transmitted and/or received by electronic devices. Such encryption techniques typically utilize channel hoping to encrypt transmission of the signals as well as data encryption of the data contained in transmitted signals. Further, permissions lists enable users to determine types of actions that are permitted to operate device functions.

### GENERAL DESCRIPTION

The present technique is directed at privacy protection for electronic devices, and selectively limiting operation of signal transmission/reception by the device to prevent any malicious signal to be collected and processed by the device. To this end, the present technique utilizes one or more signal blocking antenna units, positioned in selected proximity to respective antenna units of the electronic device. The one or more signal blocking antenna units are configured to emit selected signal, within frequency range used by the respective antenna units of the device, to thereby prevent, or at least limit, transmission and/or reception of signals by the respective antenna unit of the device. The one or more signal blocking antenna units may be installed in the electronic device itself, or in a case/bag configured for covering/protecting the electronic device.

The present disclosure provides a system, that may be configured as an additional module to be added to an electronic device, module that is integral with the device, or a case for holding the electronic device. The system comprises one or more signal blocking antenna units in a predetermined arrangement selected in accordance with arrangement of antenna units of the respective electronic device, and a control unit/circuit. The control circuit is configured to operate the one or more signal blocking antenna units, to transmit signal patterns selected to prevent transmission and/or reception of signals by (or from) the respective antenna units of the device. Typically, the signal pattern may be formed of high frequency noise signal, transmitted within the frequency range used for communication by the respective antenna unit of the device.

When operated, one or more of the signal blocking antenna units is operated to transmit a selected signal pattern, selected for interfering with communication transmitted from or received by the respective antenna unit of the device. The signal pattern is transmitted within frequency range used by the corresponding communication protocol.

More specifically, for blocking Wi-Fi communication, a signal blocking antenna positioned facing Wi-Fi antenna unit of the electronic device is operated for transmitting signal pattern in frequency range used for Wi-Fi communication. Further, as the Wi-Fi communication typically utilizes various communication channels, the technique of the present disclosure may periodically transmit the signal pattern in different channels to cover various channels used for communication. More specifically, the signal blocking antenna unit may switch transmission channel according to a predetermined, random, or pseudo-random pattern. Channel switching period may be within a time frame of about 0.1-10 milliseconds, and typically around 1 millisecond to interrupt signal transmission in a plurality of communication channels.

Thus, according to a broad aspect, the present disclosure provides a data protection system for use with an associated electronic device, the system comprising one or more signal blocking antenna unit and a control circuit; wherein:
said one or more signal blocking antenna units are positioned to face respective one or more antenna units of said associated electronic device; and
said control circuit is configured and operable to operate said one or more signal blocking antenna units to transmit selected signal pattern for blocking communication to or from the respective antenna unit of the associated electronic device.

According to some embodiments, the selected signal pattern comprises high frequency noise pattern.

According to some embodiments, the electronic device may comprise a Wi-Fi communication module comprising one or more wi-fi antenna units; said at least one signal blocking antenna units comprise at least one wi-fi signal blocking antenna unit positioned to face respective one of said one or more wi-fi antenna units of the device; said control circuit is configured and operable to operate said at least one wi-fi signal blocking antenna unit for transmitting selected signal pattern in one or more wi-fi communication channels, thereby blocking wi-fi communication to and from said electronic device.

According to some embodiments, the control circuit may be configured to operate said at least one wi-fi signal blocking antenna unit for transmitting said selected signal pattern and for periodically changing transmission channel, to thereby block wi-fi communication in a plurality of communication channels.

According to some embodiments, the electronic device may comprise a Bluetooth communication module comprising one or more Bluetooth antenna units; said at least one signal blocking antenna units comprise at least one Bluetooth signal blocking antenna unit positioned to face respective one of said one or more Bluetooth antenna units of the device; said control circuit is configured and operable to operate said at least one Bluetooth signal blocking antenna unit for transmitting selected signal pattern in one or more Bluetooth communication channels, thereby blocking Bluetooth communication to and from said electronic device.

According to some embodiments, the control circuit may be configured to operate said at least one Bluetooth signal blocking antenna unit for transmitting said selected signal pattern and for periodically changing transmission channel, to thereby block Bluetooth communication in a plurality of communication channels.

According to some embodiments, the electronic device may comprise a near field communication (NFC) module comprising one or more NFC antenna units; said at least one signal blocking antenna units comprise at least one NFC signal blocking antenna unit positioned to face respective one of said one or more NFC antenna units of the device; said control circuit is configured and operable to operate said at least one NFC signal blocking antenna unit for transmitting selected signal pattern in one or more NFC channels, thereby blocking NFC communication to and from said electronic device.

According to some embodiments, the control circuit may be configured to operate said at least one NFC signal blocking antenna unit for transmitting said selected signal pattern and for periodically changing transmission channel, to thereby block NFC communication in a plurality of communication channels.

According to some embodiments, the electronic device may comprise a positioning system communication module comprising one or more positioning system antenna units; said at least one signal blocking antenna units comprise at least one positioning signal blocking antenna unit positioned to face respective one of said one or more positioning system antenna units of the device; said control circuit is configured and operable to operate said at least one positioning signal blocking antenna unit for transmitting selected signal pattern in one or more positioning system communication channels, thereby blocking positioning system communication to and from said electronic device.

According to some embodiments, the control circuit may be configured to operate said at least one positioning signal blocking antenna unit for transmitting said selected signal pattern and for periodically changing transmission channel, to thereby block positioning system communication in a plurality of communication channels.

According to some embodiments, the one or more signal blocking antenna units comprise one or more flex printed circuit board antenna units.

According to some embodiments, the selected signal pattern comprises variation in at least one of signal strength and signal frequency.

According to some embodiments, the data protection system may be configured as a case for an electronic device. According to some embodiments, the data protection system may be configured as a case for smartphone or tablet device. The data protection system may be configured as a laptop cover, and/or attachment for a laptop.

According to some embodiments, the data protection system may be configured as an electronic module being an add-on for said electronic device. In some other embodiments, the data protection system may be configured as an electronic circuit integrated in said electronic device.

According to one other broad aspect, the present disclosure provides an electronic device comprising one or more antenna units and a data protection system, the system comprising one or more signal blocking antenna unit and a control circuit; wherein:
said one or more signal blocking antenna units are positioned to face respective one or more antenna units of said electronic device; and
said control circuit is configured and operable to operate said one or more signal blocking antenna units to transmit selected signal pattern for blocking communication to or from the respective antenna unit of the associated electronic device.

According to one other broad aspect, the present disclosure provides a case for an electronic device, the case comprises one or more signal blocking antenna unit and a control circuit; wherein:
said one or more signal blocking antenna units are positioned to face respective one or more antenna units of said electronic device; and
said control circuit is configured and operable to operate said one or more signal blocking antenna units to transmit selected signal pattern for blocking communication to or from the respective antenna unit of the associated electronic device.

According to some embodiments, the case may further comprise a power storage unit configured to provide electrical power to said one or more signal blocking antenna units and said control circuit.

According to some embodiments, the case may comprise a power connection port connectable to said electronic device and configured to obtain electrical power from said electronic device.

According to yet another broad aspect, the present disclosure provides a method for use in privacy protection for an electronic device, the method comprising:
(a) providing one or more signal blocking antenna units facing one or more respective antenna units of said electronic device;
(b) operating said one or more signal blocking antenna units for transmitting selected signal blocking pattern to thereby blocking signal transmission to and from the respective antenna units of said electronic device.

According to some embodiments, the method may further comprise varying at least one of frequency and channel of transmission of said signal blocking pattern, thereby blocking communication in a plurality of communication frequencies.

According to some embodiments, the method may further comprise varying transmission power of said signal blocking pattern.

According to some embodiments, the one or more signal blocking antenna units comprise signal blocking antenna units selected from blocking one or more communication protocols comprising: Wi-Fi communication, Bluetooth communication, NFC communication, and positioning system signal communication.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1 schematically illustrates a system according to some embodiments of the present disclosure, for use in privacy protection with a respective electronic device.

FIG. 2 shows an exemplary signal blocking antenna suitable for use with some embodiments of the present disclosure;

FIG. 3 shows a signal blocking antenna unit positioned to face internal antenna unit of a respective electronic device according to some embodiments of the present disclosure;

FIG. 4 shows location of internal antenna units of an exemplary electronic device;

FIG. 5 exemplifies signal blocking pattern transmitted by signal blocking antenna unit according to some embodiments of the present disclosure;

FIG. 6 shows frequency bands used by various positioning systems that can be blocked using some embodiments of the present disclosure; and

FIG. 7 illustrates a case for use with a mobile phone (smartphone) carrying a privacy protection system according to some embodiments of the present disclosure.

### DETAILED DESCRIPTION OF EMBODIMENTS

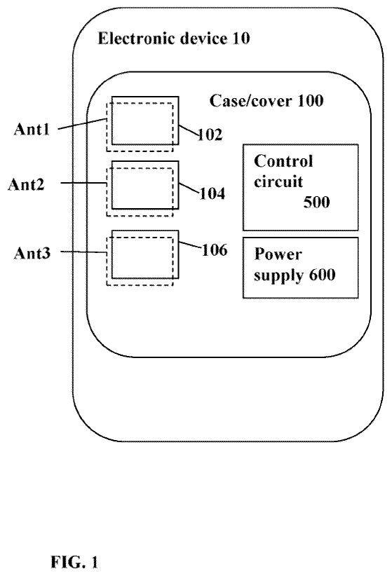

As described above, the present disclosure provides for a system, device, and a technique for use in privacy protection associated with a selected electronic device. FIG. 1 schematically illustrated a system 100, associated with a selected electronic device 10, and configured to selectively block input and output communication using one or more communication protocols. Generally, the electronic device 10 includes various elements such as processors, memory, user interfaces etc. Additionally, the electronic device includes one or more antenna units used for selected communication protocols. Three such antenna units are exemplified in FIG. 1, including Ant1, Ant2, and Ant3. For example, the antenna units may be used for Wi-Fi, Bluetooth, near field communication (NFC), and for receiving location system signals (e.g., GPS, Galileo, GLONASS, BeiDou, etc.).

System 100 includes a selected umber of signal blocking antenna units, antenna units 102, 104, and 106, are illustrated in the figure, and a control circuit 500. The signal blocking antenna units 102, 104 106, are positioned to face respective antenna units of the electronic device 10, to thereby enable blocking communication to and from the respective antenna units, while minimize interference with communication between other elements in the environment.

The control circuit 500 generally includes a signal generator, e.g., arb signal generator, configured for generating modulated signal pattern (e.g., noise pattern) within a selected bandwidth (e.g., 50-1000 MHz). The control circuit 500 may also include one or more processors and memory unit configured to operate signal generation and transmission to provide selected (and/or random) variability in signal pattern, power, and channel. To this end, the processor and memory of control circuit 500 may be operatively connected to the signal generator, and may be connected to a selected user interface, e.g., enabling turning signal blocking on or off. The processor and memory are configured to provide processing necessary for operating the system as further detailed hereinbelow. The processor can be configured to execute several functional modules in accordance with computer-readable instructions implemented in the memory (e.g., being a non-transitory computer-readable).

Generally, the control circuit 500 may also include a modulator, multiplexer and/or other elements operable for generating a selected RF signal pattern and transmission thereof while switching transmission parameters and channel.

The system 100 may also include a power supply unit 600. Power supply 600 may be a battery unit or any power source configured to provide energy for operation of the control circuit and signal blocking antenna units 102-106. In some configurations, power supply 600 may be connectable to electronic device 10, e.g., using USB connection or any other connection type, for providing power transmitted from electronic device 10.

Generally, system 100 may be configured to be directly attached to electronic device 10. To this end the system may be embedded within a case or bag configured for covering electronic device 10. Additionally, or alternatively, system 100 may be provided as external attachment to be placed on electronic device 10. Further, in some configurations, system 100 may be provided as a set of elements configured to be installed within an electronic device, to provide privacy protection as an integral part of the electronic device. When configured to be installed within an electronic device, control circuit 500 and power supply 600 may be operated by one or more processors of the electronic device 10 (e.g., as processing module and/or subroutines) and the integral power supply of device 10.

To provide blocking of communication signals, the signal blocking antenna units of the present techniques are operated for transmitting high frequency signal pattern. The signal pattern is generally of a selected noise pattern transmitted within frequency range of the respective communication protocol. Further, as the communication protocols (such as Wi-Fi and Bluetooth) include channel hoping between orthogonal channels within the same frequency range, The present technique may further operate to transmit the signal pattern within various channels. More specifically, the signal pattern is transmitted within one channel, and within a selected periodicity (or pseudo periodicity) the transmission channel is changes to another channel. Typically, channel switching is directed at blocking communication within a plurality of channels and overcoming channel hoping feature of the communication protocol. To this end the present technique may operate to switch channels according to a predetermined, random or pseudo random pattern, within a period timescale of the order of milliseconds. In some embodiments, period timescale of channel switching may be selected as T+δ, where δ is a random (or pseudo random) parameter, having expected value of 0 and standard deviation below 1 millisecond, and T is of the order of a millisecond. Generally, transmission power of the signal pattern may also be variable in accordance with a random or pseudo random pattern. Variation of signal power is generally provided to overcome noise filtering capabilities of certain communication protocols. Channel switching is used to block communication over the entire spectrum, noting channel hoping functionality of the communication protocols used.

To enable blocking communication to or from one or more selected antenna units of the electronic device, the signal blocking antenna units according to some embodiments of the present disclosure are typically positioned in close proximity to the respective antenna units of the electronic device. FIG. 2 shows an exemplary signal blocking antenna unit. The signal blocking antenna unit is generally configured as a flexible circuit antenna unit and is generally positioned to conform with respective antenna unit of the electronic device. To this end, the system of the present disclosure is generally structured as attachment to an electronic device in the form of a case, cover, bag, etc., or is configured to be integral with the electronic device. The signal blocking antenna unit exemplified in FIG. 2 is shown as a flex monopole antenna unit. However, it should be noted that various other antenna configurations may be used.

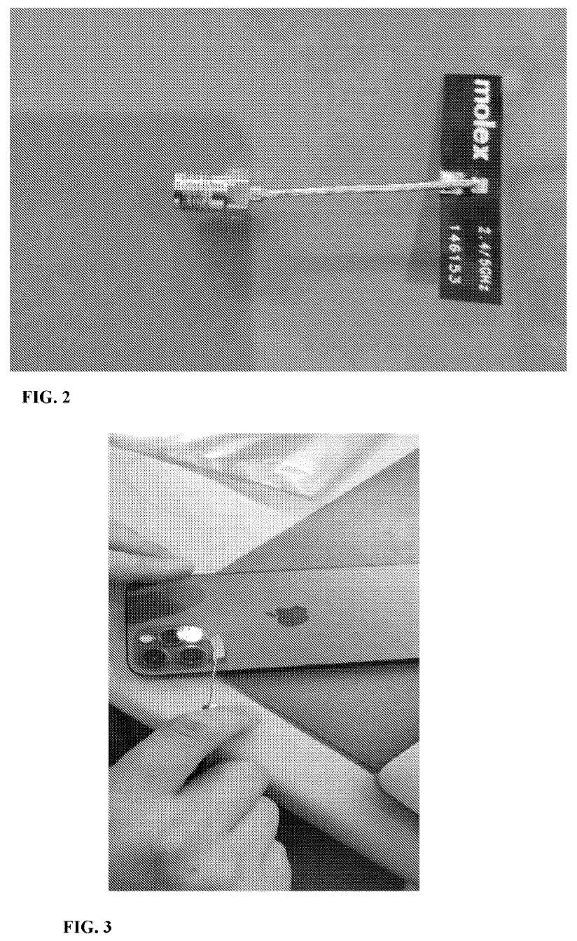

In an experimental system, a signal blocking antenna unit as shown in FIG. 2 was used for blocking Wi-Fi communication to and from a mobile phone (in this example an iPhone 11 pro). FIG. 3 shows a signal blocking antenna unit positioned above location of Wi-Fi antenna of the mobile phone. FIG. 4 shows the mobile phone with open cover, allowing direct view on the antenna units of the electronic device. Positioning the signal blocking antenna units facing the respective antenna units of the electronic device enable to increase signal interruption to the electronic device, while reducing any signal interruption to other devices in the surroundings. This enables a user to disable all communication to the user's devices, while not disturbing communication performed by other users in the surroundings.

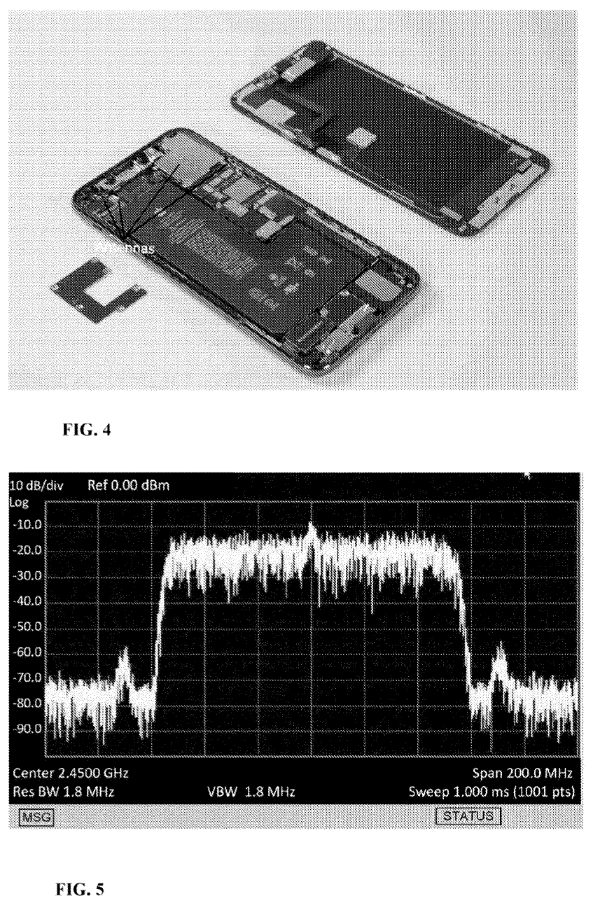

An example of transmission by a signal blocking antenna unit is shown in FIG. 5. The jamming signal was demonstrated using a vector signal generator with arb function generator for producing noise pattern. The signal pattern was noise modulated with 100 MHz bandwidth. The signal pattern was transmitted through the signal blocking antenna unit shown in FIG. 4 with transmission power around 13 dB. Generally, transmission power of 5 dBm to 25 dBm (Decibel-milliwatts) may be used. In this specific example the transmission power was set to 13 dBm. As indicated above, the transmission power is preferably varied to limit noise cancellation capabilities of various communication protocols. Signal blocking efficiency was verified by a plurality of ping requests. When operating the signal blocking antenna units to transmit the above defined signal pattern, ping requests have timed out, while proper ping time was measured with the signal blocking antenna unit not transmitting.

Positioning system blocking was tested on a mobile phone using android operating system. The mobile phone used was a Samsung Galaxy S20, using an android app for measuring GPS signal strength. The testing used monopole flex antenna unit as exemplified in FIG. 2, and a second signal blocking antenna unit formed of an exposed coaxial cable end carrying ferrite bids on the insulated regions. The signal blocking antenna units were positioned facing location of the GPS antenna unit of the mobile phone and operated to transmit signal blocking pattern directed for blocking transmission of GPS system satellites. The signal pattern was composed of high frequency white-noise signal having central frequency of 1575.42 MHz with bandwidth of 10 MHz. GPS signal power was measured indoors and outdoors using android apps ‘Data GPS’ for GPS signal strength, ‘Network cell Info lite’ for cellular network signal, and ‘Net Analyzer’ or detection of Wi-Fi signal strength.

Table 1 below shows testing results including indoor and outdoor testing with different distances between the signal blocking antenna unit and the GPS antenna unit of the mobile phone (electronic device). In the first two rows, the signal blocking antenna units were not operated for transmitting any signal, providing GPS signal power unaffected. Further, when signal blocking antenna unit was placed at a distance from antenna units of the electronic device, signal blocking was limited, and obtained at high power (−30 to −10 dBm) of the signal pattern for communication blocking. At near field, i.e., when the signal blocking antenna unit was placed facing antenna unit of the electronic device, efficient signal blocking was obtained with transmission powers of −50 dBm indoors, while partial blocking was obtained at signal power of −60 dBm. In outdoors environment, partial signal blocking was obtained with signal transmission power of −20 dBm and complete signal blocking obtained at transmission power of −10 dBm. In the testing, Cellular, Wi-Fi, and Bluetooth communication was also tested and found unaffected by GPS signal blocking, including when signal blocking transmission power was increased to +10 dBm.

TABLE 1

| GPS signal power | | | |
|---|---|---|---|
| Open coax | Monopole flex | Blocking signal | |
| antenna | antenna | power (dBm) | Test location |
| 3.30 | 1.30 | 0 | Indoor - no signal |
| | | | blocking |
| 3.45 | 1.44 | | Outdoor- no signal |
| | | | blocking |
| | 1.33 | −50 | Indoor, 1 m apart |
| | 1.33 | −50 | Indoor, 0.5 m apart |
| | Unstable signal | −30 | |
| | power | | |
| Unstable signal | No signal reception | −20 | |
| power | | | |
| | No signal reception | −10 | |
| | 1.29 | −50 | Indoor, 0.2 m apart |
| | 1.29 | −50 | Indoor, 0.1 m apart |
| | 1.18, unstable | −60 | Indoor, near field |
| | signal power | | |
| 3.26 unstable | No signal reception | −50 | |
| signal power | | | |
| No signal reception | No signal reception | −40 | |
| 3.16 unstable | | −30 | Outdoor, near field |
| signal power | | | |
| No signal reception | 1.26 unstable | −20 | |
| | signal power | | |
| | No signal reception | −10 | |

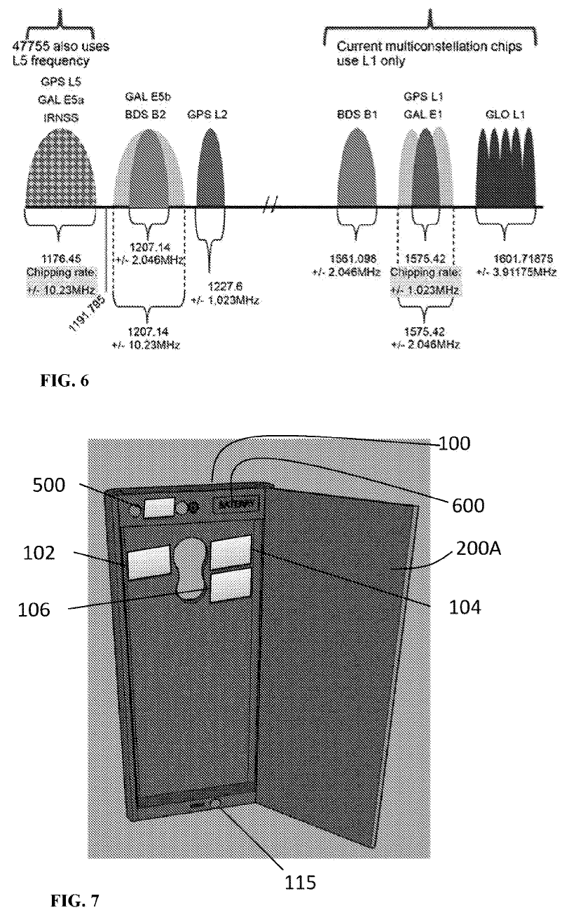

As indicated above, the testing was directed at blocking communication with GPS system as an exemplary communication band. FIG. 6 shows positioning systems communication bands, including GPS and Galileo bands around central frequency of 1575.42 MHz. As shown in the figure, different frequency bands are used for communication with respective positioning systems. Applying signal blocking at these frequency bands may be performed in substantially similar manner of transmission of signal blocking pattern within the respective frequency band as described herein above.

Reference is made to FIG. 7 exemplifying a case unit 200A for use with a mobile phone (e.g., smartphone). The case unit 200A is adapted to include a system for privacy protection 100 according to some embodiments of the present disclosure. To this end, the case unit 200A includes an arrangement of one or more signal blocking antenna units. Antenna units 102, 104 and 106 are exemplified, a control circuit 500 and power supply 600 (exemplified by a battery). The case unit 200A may also include one or more switches 115 providing user control over operation of the system 100. In accordance with user selection, e.g., by operation of switch 115, the control circuit 500 operates to transmit signal pattern as escribed above for blocking one or more wireless communication techniques of the electronic device placed within the case.

Generally, to provide tight attachment, an enable easy use of device's camera, microphone and speakers, typical cases are designed specifically for selected models of mobile phones. The case unit 200A illustrated here is generally designed for use with a specific model of electronic device in accordance with externals structure, camera, microphone, and speakers locations, as well as in accordance with locations of antenna units of the mobile phone. Accordingly, signal blocking antenna units 102-106 of the privacy protection system 100 are placed within case 200A at selected location to provide that the signal blocking antenna units 102-106 face antenna units of the electronic device. For example, a Wi-Fi signal blocking antenna unit is located to face Wi-Fi antenna unit of the electronic device, Bluetooth signal blocking antenna unit is located to face Bluetooth antenna unit of the electronic device, and similar for NFC, positioning system (GPS) and/or any other communication protocol.

The power supply 600 may be a battery unit. Additionally, or alternatively, power supply 600 may utilize connection to battery of the electronic device, e.g., via a USB connection, to provide electrical power from the electronic device.

Additionally, case unit 200A and privacy protection system 100 therein may also include a data protection system configured for preventing remotely obtaining data indicative of surroundings of the device including at least one of audio data, visual data and location data as described in PCT application PCT/IL2021/050624 assigned to the assignee of the present application.

Thus, as described herein above, the present disclosure provides a technique for selectively blocking communication to and from an electronic device. The present technique enables improved protection against hacking attaches that use wireless communication techniques, such as Wi-Fi and Bluetooth access, and may be used to prevent detection of device location by blocking positioning system communication.

1. A data protection system for use with an associated electronic device including at least one of wi-fi, Bluetooth and NFC communication modules and respective one or more antenna units, the data protection system comprising:
one or more signal blocking antenna units; and
a control circuit;
wherein:
said one or more signal blocking antenna units are positioned to face respective one or more antenna units of said associated electronic device; and
said control circuit is configured and operable to operate said one or more signal blocking antenna units to transmit selected signal pattern in one or more communication channels for blocking communication to or from the respective antenna unit of the associated electronic device; wherein said control is configured to signal said at least one signal blocking antenna unit for transmitting said selected signal pattern and for periodically changing transmission channel, to thereby block communication in a plurality of communication channels.

2. The data protection system of claim 1, wherein said selected signal pattern comprises high frequency noise pattern.

3. The data protection system of claim 1, wherein said electronic device comprises a Wi-Fi communication module comprising one or more wi-fi antenna units; said at least one signal blocking antenna units comprise at least one wi-fi signal blocking antenna unit positioned to face respective one of said one or more wi-fi antenna units of the device; said control circuit is configured and operable to operate said at least one wi-fi signal blocking antenna unit for transmitting selected signal pattern in one or more wi-fi communication channels, thereby blocking wi-fi communication to and from said electronic device.

4. The data protection system of claim 3, wherein said control circuit is configured to operate said at least one wi-fi signal blocking antenna unit for transmitting said selected signal pattern and for periodically changing transmission channel, to thereby block wi-fi communication in a plurality of communication channels.

5. The data protection system of claim 1, wherein said electronic device comprises a Bluetooth communication module comprising one or more Bluetooth antenna units; said at least one signal blocking antenna units comprise at least one Bluetooth signal blocking antenna unit positioned to face respective one of said one or more Bluetooth antenna units of the device; said control circuit is configured and operable to operate said at least one Bluetooth signal blocking antenna unit for transmitting selected signal pattern in one or more Bluetooth communication channels, thereby blocking Bluetooth communication to and from said electronic device.

6. The data protection system of claim 5, wherein said control circuit is configured to operate said at least one Bluetooth signal blocking antenna unit for transmitting said selected signal pattern and for periodically changing transmission channel, to thereby block Bluetooth communication in a plurality of communication channels.

7. The data protection system of claim 1, wherein said electronic device comprises a near field communication (NFC) module comprising one or more NFC antenna units; said at least one signal blocking antenna units comprise at least one NFC signal blocking antenna unit positioned to face respective one of said one or more NFC antenna units of the device; said control circuit is configured and operable to operate said at least one NFC signal blocking antenna unit for transmitting selected signal pattern in one or more NFC channels, thereby blocking NFC communication to and from said electronic device.

8. The data protection system of claim 7, wherein said control circuit is configured to operate said at least one NFC signal blocking antenna unit for transmitting said selected signal pattern and for periodically changing transmission channel, to thereby block NFC communication in a plurality of communication channels.

9. The data protection system of claim 1, wherein said electronic device comprises a positioning system communication module comprising one or more positioning system antenna units; said at least one signal blocking antenna units comprise at least one positioning signal blocking antenna unit positioned to face respective one of said one or more positioning system antenna units of the device; said control circuit is configured and operable to operate said at least one positioning signal blocking antenna unit for transmitting selected signal pattern in one or more positioning system communication channels, thereby blocking positioning system communication to and from said electronic device.

10. The data protection system of claim 9, wherein said control circuit is configured to operate said at least one positioning signal blocking antenna unit for transmitting said selected signal pattern and for periodically changing transmission channel, to thereby block positioning system communication in a plurality of communication channels.

11. The data protection system of claim 1, wherein said one or more signal blocking antenna units comprise one or more flex printed circuit board antenna units.

12. The data protection system of claim 1, wherein said selected signal pattern comprises variation in at least one of signal strength and signal frequency.

13. The data protection system of claim 1, configured as a case for an electronic device.

14. The data protection system of claim 13, configured as a case for smartphone or tablet device.

15. The data protection system of claim 13, configured as a laptop cover.

16. The data protection system of claim 1, configured as an electronic module being an add-on for said electronic device.

17. The data protection system of claim 1, configured as an electronic circuit integrated in said electronic device.

18. An electronic device, comprising:
one or more antenna units; and
a data protection system, the data protection system comprising one or more signal blocking antenna unit and a control circuit;
wherein:
said one or more signal blocking antenna units are positioned to face respective one or more antenna units of said electronic device; and
said control circuit is configured and operable to operate said one or more signal blocking antenna units to transmit selected signal pattern for blocking communication to or from the respective antenna unit of the associated electronic device.

19. A case for an electronic device, comprising one or more signal blocking antenna unit and a control circuit; wherein:
said one or more signal blocking antenna units are positioned to face respective one or more antenna units of said electronic device; and
said control circuit is configured and operable to operate said one or more signal blocking antenna units to transmit selected signal pattern for blocking communication to or from the respective antenna unit of the associated electronic device.

20. The case of claim 19, further comprising a power storage unit configured to provide electrical power to said one or more signal blocking antenna units and said control circuit.

21. (canceled)

22. (canceled)

23. (canceled)

24. (canceled)

25. (canceled)
